(19) United States
(12) Patent Application Publication
(10) Pub. No.: US 2007/0087250 A1
(43) Pub. Date: Apr. 19, 2007

(54) Alloy for fuel cell interconnect

(76) Inventors: Daniel Joseph Lewis, Delmar, NY (US); Melvin Robert Jackson, Corea, ME (US); Canan Uslu Hardwicke, Simpsonville, SC (US); Anthony Mark Tohmpson, Niskayuna, NY (US); Sheela Kollali Ramasesha, Bangalore (IN); Hari N. S., Banglore (IN); Aravind Dattatrayarao Chinchure, Noida (IN); Kaushik Vaidya, Bangalore (IN); Amitabh Verma, Noida (IN)

Correspondence Address: Patricks S. Yoder;FLETCHER YODER, P.O. Box 692289, Houston, TX, 77269-2289, US

(21) Appl. No.: 11/249,852

(22) Filed: Oct. 13, 2005

(51) Int. Cl. H01M 8/02; C22C 38/22

(52) U.S. Cl. 429/34; 420/40; 420/67

(57) ABSTRACT

An alloy for an interconnect for a fuel cell is provided. The alloy comprises iron at least about 60 weight percent, chromium in the range of about 15 to about 30 weight percent and tungsten in the range of about 3 to about 4.5 weight percent. The alloy also includes at least one element selected from the group consisting of aluminum, yttrium, zirconium, lanthanum, manganese, molybdenum, nickel, vanadium, tantalum, and titanium.

### STATEMENT REGARDING FEDERALLY SPONSORED RESEARCH OR DEVELOPMENT

The U.S. Government may have certain rights in this invention pursuant to contract number DE-FC26-01NT41245 awarded by the U.S. Department of Energy.

### BACKGROUND

The invention relates generally to an alloy for interconnects in a fuel cell, and more specifically to an alloy that enhances the manufacturability of the interconnects.

Fuel cells produce electricity by catalyzing fuel and oxidant into ionized atomic hydrogen and oxygen at the anode and the cathode, respectively. Free electrons removed from hydrogen in the ionization process at the anode are conducted to the cathode where they ionize the oxygen. In the case of a solid oxide fuel cell, the oxygen ions are conducted through the electrolyte where they combine with ionized hydrogen to form water as a waste product and complete the process. The electrolyte is otherwise impermeable to both fuel and oxidant and merely conducts oxygen ions. This series of electrochemical reactions is the sole means of generating electric power within the fuel cell. It is therefore desirable to reduce or eliminate any mixing of the reactants that results in a different combination, such as combustion which does not produce electric power and therefore reduces the efficiency of the fuel cell.

Fuel cells are typically assembled in electrical series in a fuel cell stack to produce power at useful voltages. To create a fuel cell stack, an interconnecting member is used to connect the adjacent fuel cells together in electrical series. When the fuel cells are operated at high temperatures, such as between approximately 600° C. and 1000° C., the fuel cells are subjected to mechanical and thermal loads that may create strain and resulting stress in the fuel cell stack. Typically in a fuel cell assembly, various elements in intimate contact with each other comprise different materials of construction, such as a metal and a ceramic. During the thermal cycles of the fuel cell assembly, elements expand and/or contract in different ways due to the difference in the coefficient of thermal expansion (CTE) of the materials of construction. In addition, individual elements may undergo expansion or contraction due to other phenomena, such as a change in the chemical state of one or more elements.

Typically, interconnects within fuel cells are metallic and comprise ferritic alloys that include tungsten or molybdenum to reduce the CTE difference between the metallic interconnects and the ceramic electrodes. However, a high percent of tungsten in the alloy reduces the manufacturability of the interconnects. That is, at certain levels of tungsten content, it has been found that defects and even cracks can occur during processing of the parts, particularly during reduction in thickness of the material.

Therefore, there is a need to design an interconnect in a fuel cell assembly that is suitable for changes in operating states including temperature cycles and changes in chemical state, and is also easy to manufacture.

### BRIEF DESCRIPTION

Briefly, according to one embodiment, an alloy for a fuel cell interconnect is provided. The alloy comprises iron at least about 60 weight percent, chromium in the range of about 15 to about 30 weight percent and tungsten in the range of about 3 to about 4.5 weight percent. The alloy also includes at least one element selected from the group consisting of aluminum, yttrium, zirconium, lanthanum, manganese, molybdenum, nickel, vanadium, tantalum, and titanium.

In another embodiment, another alloy for a fuel cell interconnect comprises iron at least about 75 weight percent, chromium at about 20 weight percent and tungsten at about 4 weight percent. The alloy also includes at least one element selected from the group consisting of aluminum, yttrium, zirconium, lanthanum, manganese, molybdenum, nickel, vanadium, tantalum and titanium.

In yet another embodiment, a fuel cell assembly includes at least one fuel cell comprising an anode, a cathode and an electrolyte interposed therebetween. The fuel cell assembly also includes an interconnect structure in intimate contact with at least one of the cathode and anode. The interconnect structure is made from an alloy. The alloy comprises iron at least about 60 weight percent, chromium in the range of about 15 to about 30 weight percent and tungsten in the range of about 3 to about 4.5 weight percent. The alloy also includes at least one element selected from the group consisting of aluminum, yttrium, zirconium, lanthanum, manganese, molybdenum, nickel, vanadium, tantalum and titanium.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary fuel cell assembly illustrating one repeat unit, and including an interconnect made of an alloy in accordance with an embodiment of the present invention; and

FIG. 2 illustrates an enlarged portion of an exemplary fuel cell assembly showing the operation of the fuel cell with the improved interconnect.

### DETAILED DESCRIPTION

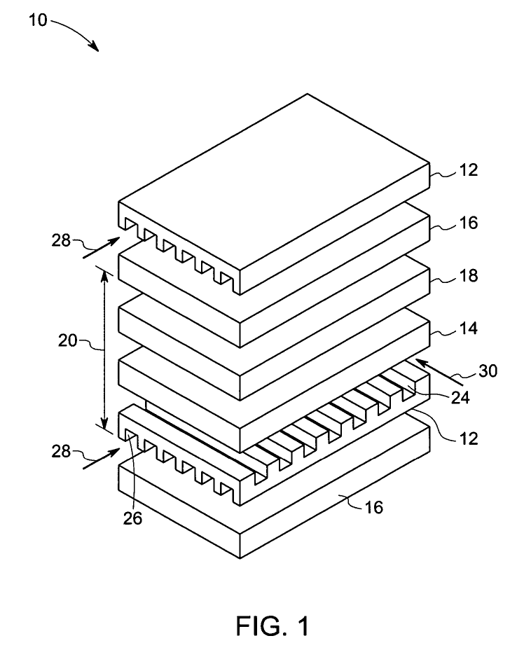

Fuel cells have demonstrated a potential for high efficiency and low pollution power generation. A fuel cell, for example a Solid Oxide Fuel Cell (SOFC), is an energy conversion device that produces electricity by electrochemically combining a fuel and an oxidant across an ionic conducting layer. An exemplary planar fuel cell 10 comprises an interconnect portion 12, a pair of electrodes, a cathode 14 and an anode 16, separated by an electrolyte 18, as shown in FIG. 1.

The interconnect portion 12 defines a plurality of airflow channels 24 in intimate contact with the cathode 14 and a plurality of fuel flow channels 26 in intimate contact with the anode 16 of an adjacent cell repeat unit 20, or vice versa. In operation, a fuel flow 28 is supplied to the fuel flow channels 26 and an airflow 30, typically heated air, is supplied to the airflow channels 24.

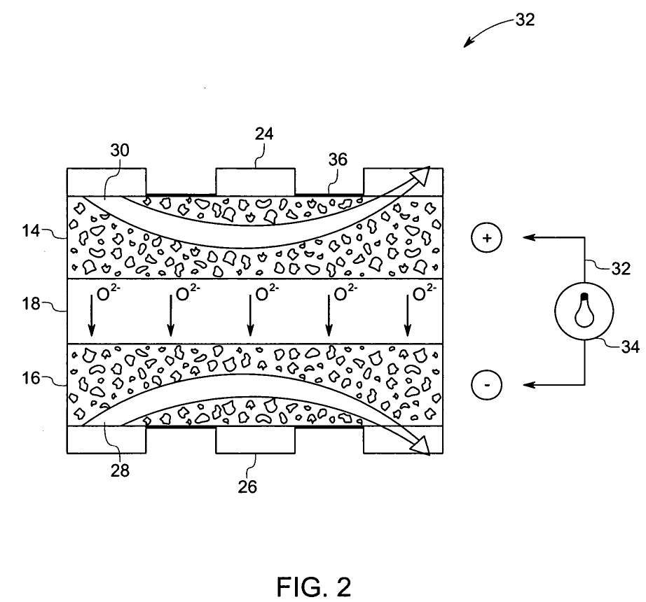

FIG. 2 shows a portion of the fuel cell illustrating the operation of the fuel cell. As shown in FIG. 2, the fuel flow 28, for example natural gas, is fed to the anode 16 and undergoes an oxidation reaction. The fuel at the anode reacts with oxygen ions (O²⁻) transported to the anode across the electrolyte. The oxygen ions (O²⁻) are de-ionized to release electrons to an external electric circuit 34. The airflow 30 is fed to the cathode 14 and accepts electrons from the external electric circuit 34 and undergoes a reduction reaction. The electrolyte 18 conducts ions between the anode 16 and the cathode 14. The electron flow produces direct current electricity and the process produces certain exhaust gases and heat.

In the exemplary embodiment as shown in FIG. 1, the fuel cell assembly 10 comprises a plurality of repeating units 20 having a planar configuration, although multiple such cells may be provided in a single structure, which structure may be referred to as a stack or a collection of cells or an assembly capable of producing a summed output.

The main purpose of the anode layer 16 is to provide reaction sites for the electrochemical oxidation of a fuel introduced into the fuel cell. In addition, the anode material should be stable in the fuel-reducing environment, have adequate electronic conductivity, surface area and catalytic activity for the fuel gas reaction at the fuel cell operating conditions and have sufficient porosity to allow gas transport to the reaction sites. The anode layer 16 can be made of a number of materials having these properties, including but not limited to, noble metals, transition metals, cermets, ceramics and combinations thereof. More specifically the anode layer 16 may be made of any materials selected from the group consisting of Ni, Ni Alloy, Ag, Cu, Cobalt, Ruthenium, Ni-YSZ cermet, Cu-YSZ cermet, Ni-Ceria cermet, or combinations thereof.

The electrolyte 18 is disposed upon the anode layer 16 typically via tape casting or tape calendaring. The main purpose of the electrolyte layer is to conduct ions between the anode layer 16 and the cathode layer 14. The electrolyte carries ions produced at one electrode to the other electrode to balance the charge from the electron flow and complete the electrical circuit in the fuel cell. Additionally, the electrolyte separates the fuel from the oxidant in the fuel cell. Accordingly, the electrolyte must be stable in both the reducing and oxidizing environments, impermeable to the reacting gases and adequately conductive at the operating conditions. Typically, the electrolyte 18 is substantially electronically insulating. The electrolyte 18 can be made of a number of materials having these properties, including but not limited to, ZrO₂, YSZ, doped ceria, CeO₂, Bismuth sesquioxide, pyrochlore oxides, doped zirconates, perovskite oxide materials and combinations thereof.

The cathode layer 14 is disposed upon the electrolyte 18. The main purpose of the cathode layer 14 is to provide reaction sites for the electrochemical reduction of the oxidant. Accordingly, the cathode layer 14 must be stable in the oxidizing environment, have sufficient electronic and ionic conductivity, surface area and catalytic activity for the oxidant gas reaction at the fuel cell operating conditions and have sufficient porosity to allow gas transport to the reaction sites. The cathode layer 14 can be made of a number of materials having these properties, including but not limited to, an electrically conductive oxide, perovskite, doped LaMnO₃, tin doped Indium Oxide (In₂O₃), Strontium-doped PrMnO₃, La ferrites, La cobaltites, RuO₂-YSZ, and combinations thereof.

Some of the functions of a typical interconnect in a planar fuel cell assembly are to provide electrical contact between the fuel cells connected in series or parallel and to provide fuel and oxidant flow passages and provide structural support. Ceramic, cermet and metallic alloys are typically used as interconnects. Metallic materials have certain advantages when used as an interconnect material because of their high electrical and thermal conductivities, ease of fabrication and low cost. In some embodiments, the fuel cell assembly may comprise fuel cells with planar configuration, tubular configuration or a combination thereof. Indeed, the alloys provided by the present techniques may benefit a range of physical fuel cell configurations, and facilitate the formation of interconnects of various designs used in such configurations.

Instability of the metallic materials in a fuel cell environment limits number of metals that can be used as interconnects. Typically, the high temperature oxidation resistant alloys form protective oxide layers on the surface, which oxide layers reduce the rate of oxidation reaction. During its service life, the temperature of a fuel cell, such as a solid oxide fuel cell, may be cycled several times between room temperature in the shut down state and operating temperatures of as high as 1000° C. During the thermal cycle in a fuel cell assembly, the elements in the fuel cell assembly including, but not limited to the anode, the cathode and the interconnects undergo thermal expansion and contraction as per the thermal CTE of the individual materials. When there is a difference in the CTE in the elements of a fuel cell assembly, which elements are in intimate contact with each other, the fuel cell assembly is under mechanical stress. This mechanical stress developed within the fuel cell may, in turn, damage the structural integrity of the fuel cell.

Therefore, metal alloys used for manufacturing of the interconnect should exhibit a number of properties. While selecting the alloy for the interconnect, properties including but not limited to oxidation resistance, CTE, area specific resistance, and manufacturability must be considered.

Disclosed herein are alloys for interconnects comprising iron at least about 60 weight percent, chromium in the range of about 15 to about 30 weight percent and tungsten in the range of about 3 to about 4.5 weight percent. The alloys further include at least one element selected from the group consisting of aluminum, yttrium, zirconium, lanthanum, manganese, molybdenum, nickel, vanadium, tantalum, and titanium.

In one embodiment, the chromium content of the alloy is in a range of about 15 weight percent to about 25 weight percent. In another embodiment, the chromium content of the alloy is about 20 weight percent. Oxidation resistant steels typically contain chromium as a major alloying element. In high temperature, oxygen containing environments, chromium preferentially oxidizes and forms a protective surface scale that typically consists of chromium oxide (Cr₂O₃). At high temperature this layer also exhibits electronic conductivity.

The tungsten content in a more specific embodiment of alloys disclosed herein is in a range of about 3.5 weight percent to about 4.5 weight percent. In one embodiment, the tungsten content of the alloy is about 4 weight percent. In a ferritic steel alloy (an iron based alloy), tungsten serves as a main strengthening element. However a higher percent of tungsten makes the alloy more difficult to process while manufacturing the interconnect sheets. Tungsten is also required for improving the CTE of the alloy to closely match to the CTE of the ceramic components in the fuel cell. When present at high levels, tungsten tends to harden the alloy. The present inventors believe, therefore, that a high percent of tungsten improves the CTE, but also creates processing defects such as cracks during processing of the alloy to form fuel cell interconnects. Typically the cracks are formed during the rolling operations when the alloy is processed to make the interconnect sheets. It is believed that a tungsten content of about 3 to about 4.5 weight percent in the alloy is an optimal level, wherein none of the required properties of the interconnect alloy is compromised. In the alloy compositions described herein, the percent of tungsten allows the improvement of the CTE of the alloy without sacrificing the manufacturability or ease of processing of the alloy.

In some embodiments, the alloy includes at least one element selected from the group consisting of aluminum, yttrium, zirconium, lanthanum, manganese, molybdenum, nickel, vanadium, tantalum, and titanium in a range of about 0.01 weight percent to about 10 weight percent. In some other embodiments, the alloy includes at least one element selected from the group consisting of aluminum, yttrium, zirconium, lanthanum, manganese, molybdenum, nickel, vanadium, tantalum, and titanium in a range of about 0.01 weight percent to about 1.0 weight percent. In one embodiment, the alloy includes lanthanum at about 0.1 weight percent and yttrium at about 0.1 weight percent. In some other embodiments, the alloy includes at least one element selected from the group consisting of manganese, molybdenum, nickel, vanadium, tantalum, and titanium in a range of about 1 weight percent to about 10 weight percent.

Aluminum increases the oxidation resistance of the alloy. However, high percentages of aluminum in the alloy decrease the strength of the alloy. Yttrium and lanthanum improve the strength of the alloy as well as oxidation resistance. Metals such as manganese, molybdenum, zirconium, nickel, vanadium, tantalum, and titanium may also be added to the alloy for improving the CTE of the alloy to match that of the non-metal components, such as the anode, cathode and electrolyte.

In another embodiment, an alloy for the interconnect includes an iron content of at least about 75 weight percent, chromium at about 20 weight percent and tungsten at about 4 weight percent. The alloy also includes at least one element selected from the group consisting of aluminum, yttrium, zirconium, lanthanum, manganese, molybdenum, nickel, vanadium, tantalum and titanium.

In some other embodiments, an alloy for the interconnect includes iron at least about 75 weight percent, chromium at about 20 weight percent and tungsten at about 4 weight percent. The alloy also includes lanthanum at about 0.1 weight percent and yttrium at about 0.1 weight percent.

In another embodiment, an alloy for the interconnect includes iron at least about 75 weight percent, chromium at about 20 weight percent and tungsten at about 4 weight percent. The alloy also includes lanthanum at about 0.5 weight percent and yttrium at about 0.5 weight percent.

All of the alloy compositions described in the preceding sections may be used for different types of fuel cells including but not limited to solid oxide fuel cells, proton exchange membrane or solid polymer fuel cells, molten carbonate fuel cells, phosphoric acid fuel cells, alkaline fuel cells, direct methanol fuel cells, regenerative fuel cells, zinc air fuel cells, or protonic ceramic fuel cells.

As shown in FIGS. 1 and 2, the interconnect portion 12 of the solid oxide fuel cell assembly 10 can be manufactured using the alloy compositions described in the preceding sections. The alloy compositions for a fuel cell interconnect disclosed herein are further illustrated in the following non-limiting example.

### EXAMPLE

A ferritic alloy composition was made containing iron, 20% of chromium, 4% tungsten, 0.5% lanthanum and 0.5% yttrium. All percentages were in weight percent. Ingots made from the alloy composition were cast and mechanically deformed into rectangular bars at elevated temperatures. The bar stock was then hot-rolled to plate having a thickness of 0.150 inches. No cracks developed in the material during the casting and hot working process. The average Vickers hardness was measured to be 200.2 HV with a standard deviation of 3.5 HV after hot rolling. The material was then repeatedly reduced in thickness using a cold rolling operation. Although it was attempted to reduce the thickness by 25% each time, measured reductions in thickness varied between 13% and 32%. The average reduction in thickness for each of seven cold rolling operations was 24%. During the processing of the sheets no cracks were detected in the rolled sheets. Hardness measurements were made after each rolling steps under a load of 500 grams, 13 seconds dwell time, on a Vickers scale. The hardness ranged from 200 to 335 HV. Compressive load tests were performed on samples taken from the same ingot. The measured yield stress for 4 samples was 45.8 ksi.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An alloy for an interconnect for a fuel cell comprising:
iron at least about 60 weight percent;
chromium in the range of about 15 to about 30 weight percent;
tungsten in the range of about 3 to about 4.5 weight percent; and
at least one element selected from the group consisting of aluminum, yttrium, zirconium, lanthanum, manganese, molybdenum, nickel, vanadium, tantalum, and titanium.

2. The alloy of claim 1, wherein the tungsten content of the alloy is in a range of about 3.5 weight percent to about 4.5 weight percent.

3. The alloy of claim 2, wherein the tungsten content of the alloy is at about 4 weight percent.

4. The alloy of claim 1, wherein the chromium content of the alloy is in a range of about 15 weight percent to about 25 weight percent.

5. The alloy of claim 1, wherein the chromium content of the alloy is about 20 weight percent.

6. The alloy of claim 1, wherein the at least one element content of the alloy is in a range of about 0.01 weight percent to about 10 weight percent.

7. The alloy of claim 1, wherein the at least one element content of the alloy is in a range of about 0.01 weight percent to about 1.0 weight percent.

8. The alloy of claim 1, wherein the at least one element content of the alloy is about 0.1 weight percent.

9. The alloy of claim 1 comprising lanthanum and yttrium.

10. The alloy of claim 9, wherein lanthanum content of the alloy is about 0.1 weight percent and yttrium content of the alloy is about 0.1 weight percent.

11. The alloy of claim 1, wherein the fuel cell is selected from the group consisting of solid oxide fuel cells, proton exchange membrane, solid polymer fuel cells, molten carbonate fuel cells, phosphoric acid fuel cells, alkaline fuel cells, direct methanol fuel cells, regenerative fuel cells, zinc air fuel cells, and protonic ceramic fuel cells.

12. An alloy for an interconnect for a solid oxide fuel cell comprising:
iron at least about 75 weight percent;
chromium at about 20 weight percent;
tungsten at about 4 weight percent; and
at least one element selected from the group consisting of aluminum, yttrium, zirconium, lanthanum, manganese, molybdenum, nickel, vanadium, tantalum and titanium.

13. A fuel cell assembly comprising:
at least one fuel cell comprising an anode, a cathode and an electrolyte interposed there between; and
an interconnect structure in intimate contact with at least one of the cathode and anode, the interconnect structure made from an alloy comprising:
iron at least about 60 weight percent;
chromium in the range of about 15 to about 30 weight percent;
tungsten in the range of about 3 to about 4.5 weight percent; and
at least one element selected from the group consisting of aluminum, yttrium, zirconium, lanthanum, manganese, molybdenum, nickel, vanadium, tantalum and titanium.

14. The fuel cell assembly of claim 13, wherein the fuel cell is a solid oxide fuel cell.

15. The fuel cell assembly of claim 13, the alloy comprising tungsten in a range of about 3.5 weight percent to about 4.5 weight percent.

16. The fuel cell assembly of claim 15, the alloy comprising tungsten at about 4 weight percent.

17. The fuel cell assembly of claim 13, the alloy comprising chromium at about 20 weight percent.

18. The fuel cell assembly of claim 13, the alloy comprising the at least one element at about 0.1 weight percent.

19. The fuel cell assembly of claim 13, the alloy comprising lanthanum and yttrium.

20. The fuel cell assembly of claim 19, the alloy comprising lanthanum at about 0.1 weight percent and yttrium at about 0.1 weight percent.
